(19) United States
(12) Patent Application Publication
(10) Pub. No.: US 2003/0061389 A1
(43) Pub. Date: Mar. 27, 2003

(54) Multi-token totally ordered group communication protocol

(76) Inventor: Sam Mazza, Fort Lee, NJ (US)

Correspondence Address: Michael A. DeSanctis, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/965,591

(22) Filed: Sep. 26, 2001

(51) Int. Cl. G06F 15/16

(52) U.S. Cl. 709/248; 709/251

(57) ABSTRACT

A method and apparatus are provided for a group communication protocol system. According to one embodiment of the invention, a logical token ring is imposed on a local area network (LAN) for each group on the LAN. A token, representing permission to send a message, is circulated among the group members. The token causes the messages of each group to be serialized independently of the other groups. According to another embodiment of the invention, the group is a replication group containing a primary entity and one or more replica entities.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

The invention relates generally to communication protocols. More particularly, the invention relates to ordered group communication protocols that utilize logical tokens for communication.

### BACKGROUND OF THE INVENTION

A necessary feature for communication protocols used in fault tolerant systems is a mechanism to guarantee that all messages can be logically ordered in a linear sequence. Fault tolerant systems use entity-replication to provide high availability services. Each member of a replication group must maintain a consistent state. This allows a replica to arrive at the last known valid state of the primary entity in the event a fault occurs. One mechanism that has been developed to guarantee that the replicas' state is consistent with that of the primary entity is to impose a total order of messages.

An example of a current technique used to impose a total order of messages will now be described with reference to FIG. 1A. FIG. 1A illustrates a logical token ring 105 superimposed on a Local Area Network (LAN) 100, such as an Ethernet. A token 110 is circulated around the nodes 120-127 on the LAN 100. A node that wishes to send a message may only do so when it has ownership of the token 110. Upon receipt of the token 110, the sender generates the next sequence number for the message about to be sent. This procedure guarantees that all messages can be logically ordered in a linear sequence, thus providing for a total order of messages for all nodes on the LAN 100.

Each of the nodes 120-127 could be a member of one or more groups. FIG. 1B illustrates one example of group membership. Groups 130, 140, or 150 could be a replication group or another type of distributed application group that requires total ordering of messages. In this example, node 124 is a member of group 130. Node 121 is a member of groups 130 and 140. Nodes 120 and 127 are members of group 140. Nodes 122, 123, and 125 are members of group 150.

The total ordering of messages only needs to be imposed on messages within each group 130, 140, and 150. However, the prior art approach imposes a total ordering of messages on the LAN 100 as a whole without regard for groups. Consequently, if node 122 wishes to send a message to the other members of its group, it may have to wait for the token to travel around all of the nodes 123-121 before it can receive the token 110 and transmit its message. An additional shortcoming is that members of different groups may not transmit messages to their respective groups concurrently. For example, a member of group 130 may not transmit a message to its group simultaneous with node 122's message.

A local area network may have many groups communicating. The use of a single token when multiple groups are present unnecessarily serializes unrelated communication. This adds unneeded latency to group communication.

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements and in which:

FIG. 1A is a block diagram that illustrates a logical token ring superimposed on a local area network.

FIG. 1B is a block diagram that illustrates group membership.

FIG. 2 is an example of a typical computer system upon which one embodiment of the present invention can be implemented.

FIG. 3 is a block diagram illustrating multiple logical token rings superimposed on a local area network to facilitate concurrent transmissions among multiple groups according to one embodiment of the present invention.

FIG. 4 is a flow diagram that illustrates message transmission processing according to one embodiment of the present invention.

FIG. 5A illustrates two replication groups where the primaries are both members of the logical token rings associated with each replication group.

FIG. 5B is a flow diagram that illustrates sending a message to the replication group from one of the primaries according to one embodiment of the present invention.

FIG. 6A illustrates two replication groups where a replica replicates both primaries.

FIG. 6B is a flow diagram that illustrates, according to one embodiment of the present invention, receiving a message at the replica that is replicating both primaries

FIG. 7 is a flow diagram that illustrates updating an all received up-to (aru) field according to one embodiment of the present invention.

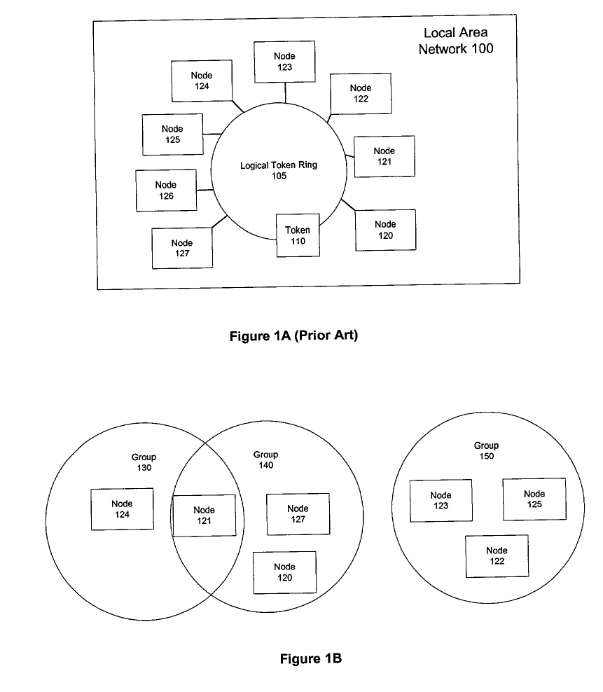

### DETAILED DESCRIPTION OF THE INVENTION

A method and apparatus are described for performing group communication. According to one embodiment of the present invention, multiple logical token rings are imposed on a LAN (one for each group on that LAN). A token representing permission to broadcast a message circulates among the members of the group. The multiple tokens enable communications for each group to be independently serialized from the other groups. This allows multiple groups to communicate simultaneously, thus reducing latency.

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various steps, which will be described below. The steps of the present invention may be performed by hardware components or may be embodied in machine-executable instructions, which may be used to cause a general-purpose or special-purpose processor or logic circuits programmed with the instructions to perform the steps. Alternatively, the steps may be performed by a combination of hardware and software.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Importantly, while embodiments of the present invention will be described with reference to the Totem Protocol as described in “Totem: A Reliable Ordered Delivery Protocol for Interconnected Local-Area Networks,” Deborah A. Agarwal (Doctoral Dissertation, Department of Electrical and Computer-Engineering, University of California, Santa Barbara, August 1994), the method and apparatus described herein are equally applicable to other types of group communication protocols that utilize logical token rings to serialize communication or future enhancements to the Totem protocol.

Terminology

Before describing an exemplary environment in which various embodiments of the present invention may be implemented, some terms that will be used throughout this application will briefly be defined.

A node generally refers to a processing element on a network. For example, a node may represent one or more processors executing one or more processes each of which may belong to one or more groups.

The term logical token ring refers to those nodes that receive a particular token. The token is passed from one node to another in an ordering that can be regarded as a “logical ring.” In the examples discussed in this application, the token represents permission to send a message. Other uses for the token may be possible.

“Passing” a token broadly refers to releasing control or ownership of the token. According to one embodiment, token passing may be performed by the current owner of the token transmitting it to the next node on a list. Other methods to share the token between group members may also be employed.

A group is a set of entities that maintain serialized communication across a network. An entity may be a node, a computer, a processor, a process, a software object, or another type of hardware device. Exemplary groups include replication groups, process groups, or nodes participating in the execution of a distributed application.

Total order means that all messages can be logically ordered in a linear sequence.

Agreed delivery means that when a message is delivered, the group member has delivered all messages within the group with an earlier timestamp.

Safe delivery means that before delivering a message, a group member knows that the other group members have received the message.

The term replication group refers to a group of entities, comprising a primary entity and one or more replica entities that replicate the state of the primary entity. A “hot replica” is a replica that is executing along with the primary.

A “warm replica” refers to a replica that is ready to run, but will need to retrieve the prior state and/or may retrieve and execute messages from the point in time of the prior state to the point of failure of the primary.

A “cold replica” refers to a replica that is not running. The replica will need to be launched in the case of failure of the primary. The cold replica will also need to retrieve the prior state and/or may retrieve and execute messages from the point in time of the prior state to the point of failure of the primary.

Totem is a fault tolerant multicast communication protocol that uses a single token on a LAN to serialize communications on the network. The senders are allowed to send a message only when they have ownership of the token. Totem provides for agreed delivery and safe delivery. The fields of a totem token include a type field, a ring identifier field, a token sequence number, a high-water mark indicating the largest sequence number of any message that has been broadcast on the ring, an all received up-to field that is used to determine which messages processors on the ring have received, a field identifying the processor that set the all received up-to field, and a retransmission request list. Each message in Totem includes a sender identifier, a ring identifier, a message sequence number, and the contents of the message. The processors each maintain local variables including a sequence number that indicates the processor has received all messages with sequence numbers less than or equal to the sequence number, the value of the token sequence number when the processor last forwarded the token, and the sequence number of the message the processor most recently delivered.

An Exemplary Node

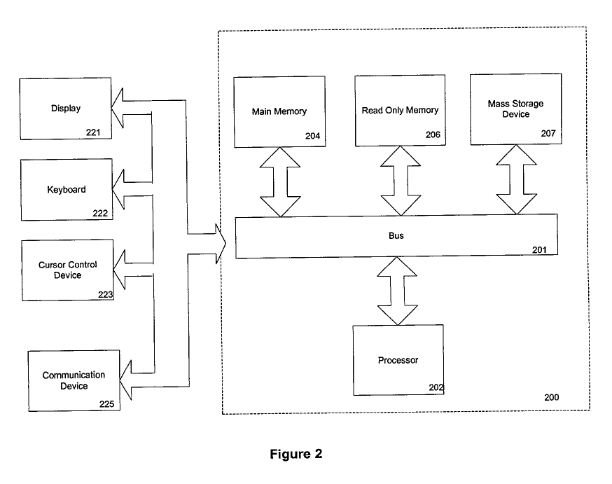

A computer system 200 representing an exemplary node 120-127 in which features of the present invention may be implemented will now be described with reference to FIG. 2. Computer system 200 comprises a bus or other communication means 201 for communicating information, and a processing means such as a processor 202 coupled with bus 201 for processing information. Computer system 200 further comprises a random access memory (RAM) or other dynamic storage device 204 (referred to as main memory), coupled to bus 201 for storing information and instructions to be executed by processor 202. Main memory 204 also may be used for storing temporary variables or other intermediate information during execution of instructions by processor 202. Computer system 200 also comprises a read only memory (ROM) and/or other static storage device 206 coupled to bus 201 for storing static information and instructions for processor 202.

A data storage device 207 such as a magnetic disk or optical disc and its corresponding drive may also be coupled to computer system 200 for storing information and instructions. Computer system 200 can also be coupled via bus 201 to a display device 221, such as a cathode ray tube (CRT) or Liquid Crystal Display (LCD), for displaying information to a computer user. Typically, an alphanumeric input device 222, including alphanumeric and other keys, may be coupled to bus 201 for communicating information and/or command selections to processor 202. Another type of user input device is cursor control 223, such as a mouse, a trackball, or cursor direction keys for communicating direction information and command selections to processor 202 and for controlling cursor movement on display 221.

A communication device 225 is also coupled to bus 201 for access to the network, such as LAN 100. The communication device 225 may include a modem, a network interface card, or other well-known interface devices, such as those used for coupling to an Ethernet, token ring, or other types of networks. In any event, in this manner, the computer system 200 may be coupled to a number of clients and/or servers via a conventional network infrastructure, such as a company's Intranet and/or the Internet, for example.

It should be appreciated that this invention is not limited to the exemplary node described in this example. In alternative embodiments, nodes may also comprise various combinations of computers, processors, other hardware devices, software processes, or other software objects. Nodes may also be coupled to alternate network infrastructures, such as a wireless network.

Multiple Logical Token Rings on a LAN

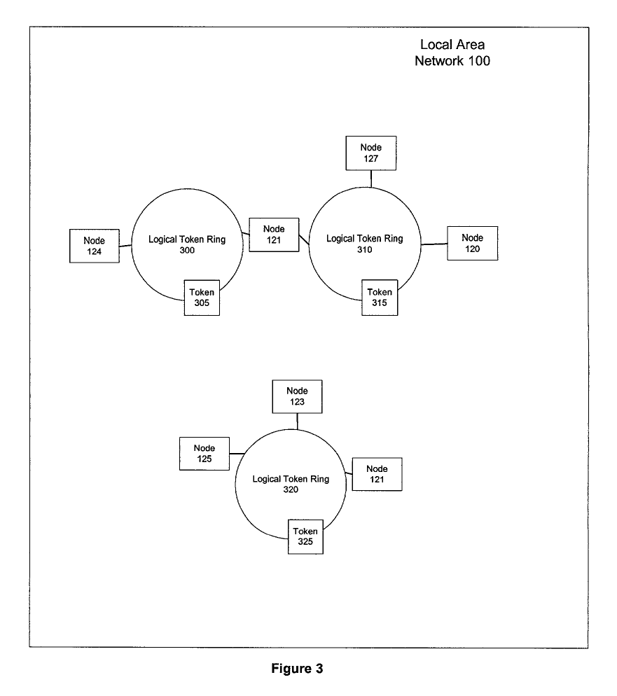

FIG. 3 illustrates multiple logical token rings 300, 310, and 320 on a LAN 100, according to one embodiment of the invention. In this example, there is a logical token ring 300, 310, and 320 for each group 130, 140, and 150. Token 305 is circulated among the nodes 121 and 124 of group 130. Token 315 is circulated among the nodes 120, 121, and 127 of group 140. Token 320 is circulated among the nodes 121, 123, and 125 of group 150. Each token 305, 315, and 325 is used to serialize messages among members of the corresponding group.

It should be appreciated that the present invention is not limited to a token circulating among the nodes on a LAN. For example, the nodes of a group may span multiple LANs. The token may also be passed among members of a group on a communication means other than a LAN, such as a bus or a data communication system within a single processor or multiprocessor computer system. Additionally, the logical token ring may be configured so that the token arrives at a node more than once before it arrives to another node at all. Finally, it is contemplated that tokens might be implemented as shared resources with an arbitration mechanism to resolve conflicting requests for the tokens.

Message Transmission Processing

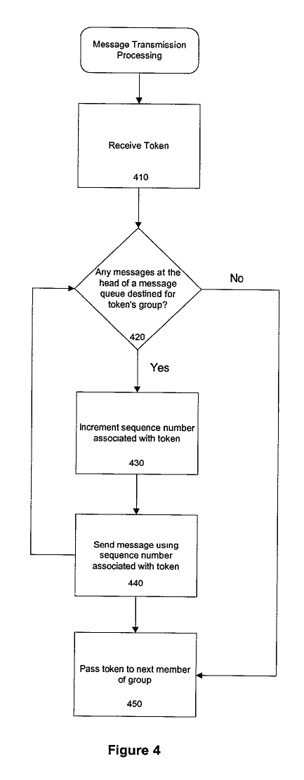

A node that wishes to send a message to a group may only do so when it has ownership of that group's token. Message transmission processing according to one embodiment of the invention will now be illustrated with reference to FIG. 4. At block 410, the node receives a token.

At block 420, the node checks to see if it has any messages at the head of a message queue that are destined for the received token's group. The node may be managing one or more message queues. If there is a message at the head of a queue destined for the received token's group, processing continues with block 430. Otherwise, processing continues with block 450. This example assumes that the node is using FIFO (First In First Out) to send its messages. In another embodiment of the invention, the node may be using another approach to managing its messages. In any event, upon receiving a token, the node checks its message queues according to the message management approach utilized and makes a determination regarding which messages, if any, are ready for transmission.

At block 430, the node increments a sequence number associated with the token. The sequence number is used to provide agreed delivery and a total order of messages among members of a process group.

At block 440, the node sends the message using the sequence number associated with the token. The message may be a unicast, multicast, or broadcast message. In block 450, the node passes the token to the next member of the group. In another embodiment, before passing the token to the next member of the group, the node may return to block 420 and continue sending messages until there are no messages at the head of its queue destined for the token's group, or until a specific event, such as a time out, has occurred.

Although the previous example illustrates the node incrementing a sequence number associated with the token and then sending a message using the new sequence number (pre-increment), it should be appreciated that alternate approaches may also be used. Another algorithm may be used to generate the sequence number. For example, the node may also send a message using the current sequence number and then generate a new sequence number before sending another message or passing the token to the next member of the group (post-increment).

Replication Groups

Fault tolerant systems use entity replication to provide high availability services. The replica entities maintain a consistent state with the entity being replicated (primary). Total order of messages guarantees that the replicas' state is consistent with that of the primary. A total order of messages is provided for each replication group. Messages are processed in the same order on the primary and its replicas. Typically, the message sequence number is the imposed order. In one embodiment, replication groups utilize a token to provide message sequence numbers. Other methods to impose total order are also possible. For example, a pre-selected entity may define an order on the messages and notify or forward the messages or the now specified order of the messages to the members of the group.

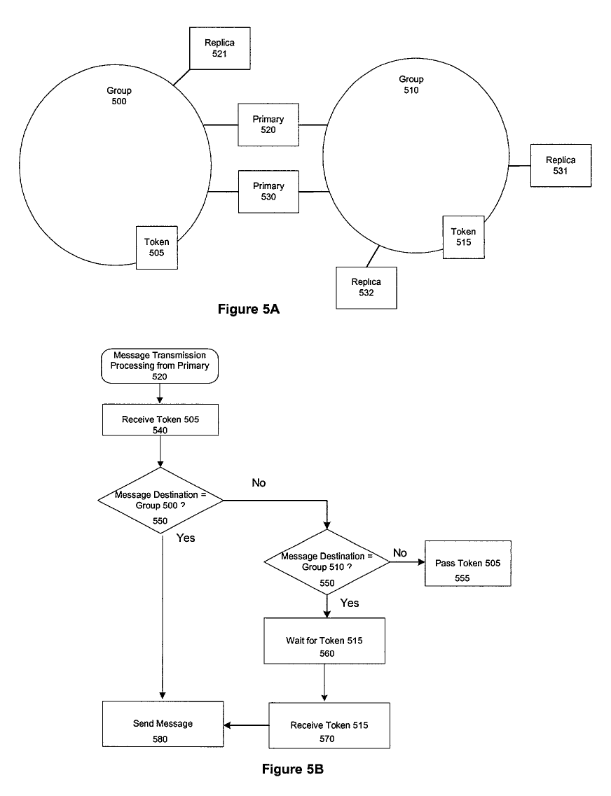

FIG. 5A illustrates two replication groups 500 and 510. Group 500 contains a replica 521 for primary 520. Group 510 contains replica processors 531 and 532 for primary 530. Token 505 is circulated among the members of group 500. Token 515 circulates among the members of group 510.

In this example, the primaries 520 and 530 need to communicate with each other. For example, one primary could be a client and the other could be a server. According to this embodiment, both primaries are responsible for maintaining message synchronization among the groups 500 and 510. Therefore, primaries 520 and 530 are each members of both groups 500 and 510.

FIG. 5B illustrates message transmission processing from primary 520. At block 540, the primary 520 receives token 505. At block 550, the primary 520 checks to see if it has any messages that need to be sent to group 500. If a message is destined for the primary's own replication group 500, the message does not need to be synchronized with group 510. Therefore, the primary may proceed with block 580.

If there are no messages that need to be sent to group 500, the primary 520 checks to see if it has any messages that need to be sent to group 510. If it does not have any messages for group 510, the primary 520 has no messages that require the use of token 505. Thus, processing continues with block 555 where the token 505 is passed to the next member of group 500.

If the primary 520 has any messages destined for group 510, processing continues at block 560. The message to group 510 needs to be synchronized between both the primary's own replication group 500 and group 510. Primary 520 needs token 515 to send a message to group 510. Token 505 is needed to ensure replica 521 receives notification of the message primary 520 sent to group 510 and thus maintains a consistent state with primary 520. Therefore, at block 560, the primary 520 must wait for token 515. At block 570, the primary 520 receives token 515. Message synchronization between the groups 500 and 510 can now be maintained. At block 580, the message is sent.

In this illustration, both primaries were responsible for maintaining message synchronization among the replication groups 500 and 510. In another embodiment of the invention, this responsibility could be delegated to one of the primaries. In that case, only the primary responsible for maintaining the message synchronization would be a member of both groups 500 and 510.

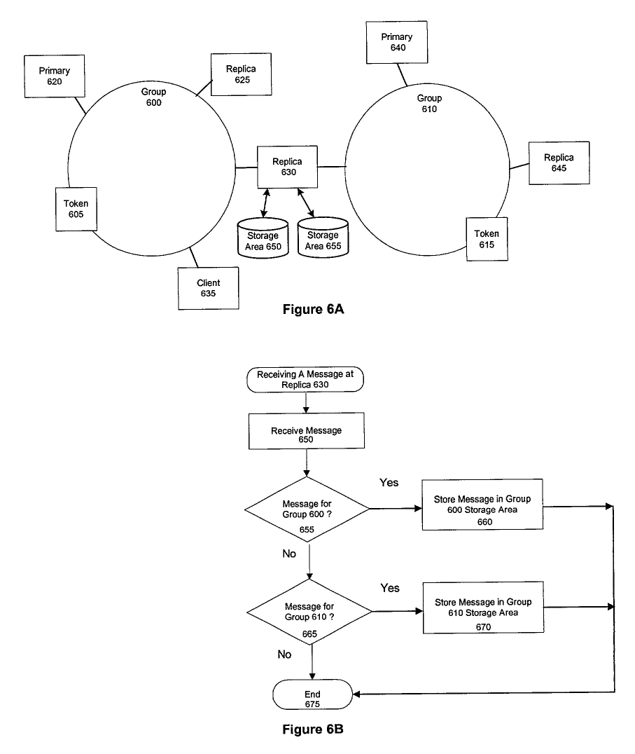

In another embodiment of the invention, a replica may replicate more than one primary. This is illustrated in FIG. 6A. Primary 620, replicas 625 and 630 and client 635 are members of group 600. Primary 640 and replicas 630 and 645 are members of group 610. Token 605 circulates among the members of group 600. Token 615 circulates among the members of group 610.

Storage areas 650 and 655 are provided to allow replica 630 to maintain separate ordered lists of messages from groups 600 and 610. Storage areas 650 and 655 may comprise a file, a part of a database, magnetic tape, magnetic disk, memory resident data structures, or another type of storage mechanism. Since replica 630 replicates both primary 620 and primary 640, it cannot act as a hot replica for both. Therefore, in this example, replica 630 is assumed to be a warm replica for both primaries 620 and 640. Importantly, in this example, message synchronization at replica 630 is by way of separate storage areas rather than tokens.

In this embodiment, replica 630 replicates both primary 620 and primary 640. Message receipt at replica 630 is illustrated in FIG. 6B. At block 650, the replica 630 receives a message. At block 665, replica 630 determines if the message was for group 600. If it was, processing continues with block 660. Otherwise, processing continues with block 665.

At block 660, the message is stored in the group 600 storage area. If the primary 620 fails, the replica 630 can then execute all of the messages in the group 600 storage area to achieve the last known state of the primary 620. After the message is stored, processing ends at block 675.

At block 665, the replica 630 determines if the message it received was for group 610. If not, processing ends at block 675. If the message was destined for group 610, processing continues with block 670.

At block 670, the replica stores the message in the group 610 storage area. If the primary 640 fails, the replica 630 can then execute all of the messages in the group 610 storage area to achieve the last known state of the primary 640. After the message is stored, processing ends at block 675.

In this example, replica 630 did not maintain its state with either of the primaries 620 or 640. In alternate embodiments, it should be appreciated that replica 630 may maintain its state, or act as a hot replica, for one of the primaries 620 or 640 and act as a warm or cold replica for the other primary 620 or 640. After receipt of a message, replica 630 would then alter its state for the primary for which it was a hot replica and store the message for the primary for which it was a warm or cold replica. It should also be appreciated that the primary may push a state onto a replica periodically or a replica may periodically ask the primary for its state.

Safe Delivery

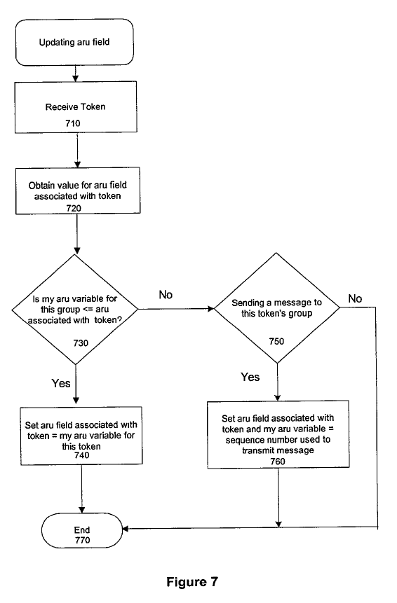

In one embodiment of the invention, a token may have an associated all received up-to (aru) field. The aru field may be used to provide safe delivery by informing all nodes on the ring of the last message that other group members have received. In this embodiment, in addition to the aru field associated with a token, each node also maintains a local aru variable for each group in which it participates that contains the last message the node received. FIG. 7 illustrates a node updating the aru field.

At block 710, the node receives a token. At block 720, the node obtains the value for the aru field associated with the token. At block 730, the node determines if its local aru variable for the token's group is less than or equal to the aru field associated with the token. If it is, processing continues with block 740. Otherwise, processing continues with block 750.

At block 740, the node sets the aru field associated with the token equal to its aru variable for this token. Processing then ends at block 770.

At block 750, the node determines if it is sending a message to this token's group. If it is, in block 760, the aru field associated with the token and the node's local aru variable are set to equal the sequence number used for the message. Processing then ends at block 750. If the node is not sending a message to the token's group, the aru field is not updated and processing ends at block 770.

Previous illustrations have shown a token having a sequence number and/or aru field associated with it. In alternate embodiments, the token may have other fields associated with it. For example, in one embodiment, the token may be a Totem token having a type field, a ring identifier field, a token sequence number, a high water mark indicating the last sequence number of any message that has been broadcast on the ring, an aru field used to determine which messages processors on the ring have received, a field identifying the processor that set the aru field, and a retransmission request list.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A group communication protocol system comprising:
a plurality of nodes on a first local area network (LAN), the plurality of nodes logically divided into at least a first group and a second group;
a first token to circulate among members of the first group to cause communications among the members of the first group to be serialized; and
a second token to circulate among members of the second group to cause communications among the members of the second group to be serialized independent of the first group.

2. The system of claim 1, wherein at least one member of the first group is also a member of the second group.

3. The system of claim 1, wherein ownership of the first token is needed before a node can send a message to the first group.

4. The system of claim 1, wherein the communication among the members of the first group comprises multicast messages.

5. The system of claim 1, wherein the communication among the members of the second group comprises broadcast messages.

6. The system of claim 1, wherein the first and second tokens include a sequencing mechanism.

7. The system of claim 1 further comprising one or more nodes on a second LAN, wherein the one or more nodes on the second LAN are members of the first group.

8. The system of claim 1, wherein the first and second groups comprise replication groups, each including at least one primary and at least one replica.

9. A group communication protocol system comprising:
a plurality of nodes logically divided into at least a first group and a second group;
a first token to circulate among members of the first group to cause communications among the members of the first group to be serialized; and
a second token to circulate among members of the second group to cause communications among the members of the second group to be serialized independent of the first group.

10. The method of claim 9, wherein ownership of the first token is needed before a node can send a message to the first group.

11. The system of claim 9, wherein the communication among the members of the first group comprises unicast messages.

12. A method comprising:
independently serializing message communication among members of a first group and members of a second group on a local area network (LAN) by circulating a first token among members of the first group; and
circulating a second token among members of the second group.

13. The method of claim 12, wherein the members of the first group include a primary entity and at least one replica for the primary entity.

14. The method of claim 12, wherein the members of the second group include a primary entity and at least one replica for the primary entity.

15. The method of claim 12, wherein the first token includes a sequence number.

16. The method of claim 15, further comprising:
a. receiving the first token at a first member of the first group;
b. incrementing the sequence number
c. sending a broadcast message to the first group using the sequence number;
d. repeating b-c for each message, if any, at the head of one or more message queues of the first member that are destined for the first group or until a specified event has occurred; and
e. passing the first token to the next member of the first group.

17. A method comprising:
receiving, at a first member of a first group on a local area network (LAN), a first token associated with the first group from another member of the first group on the LAN;
incrementing a sequence number associated with the first token;
sending a message to the members of the first group using the sequence number associated with the first token;
passing the first token to a next member of the first group on the LAN;
receiving, at a member of a second group on the LAN, a second token associated with the second group from another member of the second group on the LAN;
incrementing a sequence number associated with the second token;
sending a message to the members of the second group using the sequence number associated with the second token; and
passing the second token to a next member of the second group on the LAN.

18. The method of claim 17 further comprising:
replacing an all received up-to (aru) field associated with the first token with a lower aru associated with the first member of the first group.

19. The method of claim 17, wherein the sending a message to the members of the first group comprises sending a multicast message.

20. A replication group system comprising:
a first replication group located on a local area network (LAN), the first replication group including a first primary entity and a first group of one or more replica entities wherein members of the first replication group are members of a first group;
a second replication group located on the LAN, the second replication group including a second primary entity and a second group of one or more replica entities wherein members of the second replication group are members of a second group;
an intersection between the first replication group and the second replication group including at least one replica entity that is a member of both the first group and the second group;
a first token circulating among members of the first group causing communications among the members of the first replication group to be ordered; and
a second token circulating among members of the second group causing communications among the members of the second replication group to be ordered independent of the first replication group.

21. The system of claim 20 further comprising:
a first storage area associated with the intersection, comprising serialized messages for the first replication group; and
a second storage area associated with the intersection, comprising serialized messages for the second replication group.

22. The system of claim 20, wherein at least one replica entity in the intersection operates as a warm or cold replica for the first primary entity and a warm or cold replica for the second primary entity.

23. The system of claim 20, wherein at least one replica entity in the intersection operates as a hot replica for the first primary entity and a warm or cold replica for the second primary entity.

24. A method comprising:
receiving at a first primary entity of a first replication group on a first local area network (LAN) a first token associated with the first replication group, the first token logically imposing a first token ring upon the first replication group, the first replication group including the first primary entity and a first group of one or more replica entities;
receiving at the first primary entity a second token associated with a second replication group on the first LAN, the second token logically imposing a second token ring upon the second replication group, the second replication group including a second primary entity and a second group of one or more replica entities;
incrementing a sequence number associated with the first token;
incrementing a sequence number associated with the second token;
sending a message from the first primary entity to the first replication group using the sequence number associated with the first token; and
sending a message from the first primary entity to the second replication group using the sequence number associated with the second token.

25. The method of claim 24, wherein the first replication group further comprises a replica entity located on a second LAN.

26. The method of claim 24, wherein the first and second tokens comprise Totem tokens.

27. A method comprising:
a step for receiving at a node on a local area network (LAN) a first token associated with a first group on the LAN;
a step for sending a first message to the members of the first group using a sequence number associated with the first token;
a step for passing the first token on to a next member of the first group;
a step for receiving at a second node on the LAN a second token associated with a second group on the LAN;
a step for sending a message to the members of the second group using a sequence number associated with the second token; and
a step for passing the second token on to a next member of the second group.

28. The method of claim 27 further comprising:
a step for incrementing the sequence number associated with the first token; and
a step for incrementing the sequence number associated with the second token.

29. The method of claim 27, wherein the first and second tokens comprise Totem tokens.

30. A machine-readable medium having stored thereon data representing sequences of instructions that when executed cause a machine to:
receive a first token associated with a first group on a local area network (LAN);
send a message to the members of the first group using a sequence number associated with the first token;
receive a second token associated with a second group on the LAN; and
send a message to the members of the second group using a sequence number associated with the second token.

31. The machine-readable medium of claim 30 further including instructions to:
increment the sequence number associated with the first token; and
pass the first token to a next member of the first group.

32. The machine-readable medium of claim 30 wherein the first and second tokens comprise Totem tokens.

33. A group communication system comprising:
a plurality of nodes on a local area network (LAN) logically divided into a first group and a second group;
a first token means, circulating among members of the first group, for serializing multicast communications among the members of the first group; and
a second token means, circulating among members of a second group, for serializing multicast communications among the members of the second group independent of the first group.

34. The system of claim 33 wherein the first and second token means include a sequence number.

35. The system of claim 34, wherein ownership of the first token means is needed before a node can send a message to the first group.

36. A method comprising:
imposing a first logical token ring on a local area network (LAN) and serializing communications among a first subset of nodes on the LAN by causing a first token to be circulated among the first subset of nodes; and
imposing a second logical token ring on the LAN and serializing communications among a second subset of nodes on the LAN by causing a second token to be circulated among the second subset of nodes.

37. The method of claim 36, wherein the first and second tokens comprise Totem tokens.

38. The method of claim 36, wherein ownership of the first token is needed before a node can send a message to the first subset of nodes.
